(19) United States
(12) Patent Application Publication
(10) Pub. No.: US 2013/0136665 A1
(43) Pub. Date: May 30, 2013

(54) SYSTEM FOR PRODUCING OIL FROM WASTE MATERIAL AND CATALYST THEREOF

(71) Applicants: Moon Chan Kim, Chungcheongbuk-do (KR); Jung Rim Lee, Chungcheongbuk-do (KR)

(72) Inventors: Moon Chan Kim, Chungcheongbuk-do (KR); Jung Rim Lee, Chungcheongbuk-do (KR)

(21) Appl. No.: 13/402,896

(22) Filed: Feb. 23, 2012

(30) Foreign Application Priority Data
Nov. 30, 2011 (KR) 10-2011-0127014

(51) Int. Cl. B01J 19/00; B01J 23/16; B01J 23/14; B01J 23/00; B01J 23/06

(52) U.S. Cl. 422/187; 502/64; 502/66

(57) ABSTRACT

A system for producing oil from waste material includes a catalytic decomposition reactor providing a stirrer for stirring at least one kind of raw material; the raw material being selected from a group consisting of lingo cellulosic hydrocarbon, biomass like marine plants, waste plastic, waste, waste oil, RDF (Refuse derived fuel) and RPF (Refuse plastic fuel), and a catalyst for decomposing the selected raw materials; the catalytic decomposition reactor serving for decomposing the raw materials and producing vapor and gaseous oil and sludge; a condenser for condensing the gaseous oil generated from the catalytic decomposition reactor; a storing container for storing oil condensed from the condenser; and a distillation tower oil from the storing container by heat from a steam boiler and collecting heavy oil, diesel oil and gasoline through a heavy oil output port, a diesel output port and a gasoline output port in boiling points.

### TECHNICAL FIELD

The present invention relates to a system for producing oil from waste material and a catalyst thereof, and particularly, to a system which performs catalyst treatment of waste oil, organic waste, waste plastic, biomass like marine plants, and lignocellulosic hydrocarbon, e.g., residues remained after extracting oil from stems of crops, palm trees, canola or jatropha, and then produces oil such as gasoline, diesel oil and heavy oil. Further, the present invention relates to a catalyst thereof.

### BACKGROUND OF THE INVENTION

In order to provide new renewable energy, a technology for producing biodiesel from soybean oil, canola oil, palm oil, jatropha oil or the like and a technology for producing bioethanol from starch crops such as corn, cassava, potato, sweet potato or the like have been widely researched and also have been utilized actually. However, since these technologies extract oil from food crops, it is difficult to avoid responsibility for the global food shortage problem.

Therefore, it has been attempted to obtain oil from biomass like marine plants, and lignocellulosic hydrocarbon, e.g., residues remained after extracting oil from stems of crops, palm trees, canola or jatropha, and also another technology for obtaining oil from organic waste or waste plastic has been researched. As an apparatus and a method for treating the waste materials, there have been proposed a method of producing bioethanol or biodiesel using hot steam of 150 to 200° C. in PCT International Publication WO2009/095693 A2, and a batch type method for producing biodiesel in an autoclave using steam in U.S. Pat. No. 5,190,226. Further, there has been also proposed a continuous process of producing biodiesel using steam in U.S. Pat. No. 6,752,337.

In Japanese Patent Publication Nos. 2002-285171, 2002-121571 and 2002-088379, there are disclosed methods and systems for gasifying biomass. In Korean Patent No. 10-330929, there is disclosed a catalyst which is prepared by ion-exchanging clinoptilolite zeolite with hydrogen, and in Korean Patent No. 10-322663, there is disclosed a catalyst which is contacted with nickel or nickel alloy catalyst and thus treated by a dehydrogenation reaction.

In U.S. Pat. Nos. 3,966,883, 4,088,739 and 4,017,590, there are disclosed methods of preparing zeolite catalyst. However, it is difficult to convert the waste plastic or lignocellulosic hydrocarbon into oil using the zeolite catalyst.

Further, in PCT International Publication WO2007/122967, there is a disclosed a method of decomposing the waste plastic and organic material using titanium oxide, and in Japanese Patent Publication No. 2009-270123, there is also disclosed a method of decomposing the waste plastic and organic material using titanium oxide. However, it is also difficult to directly convert the lignocellulosic hydrocarbon into oil using these methods.

### SUMMARY OF THE INVENTION

An object of the present invention is to provide a system which can produce high quality of oil such as gasoline, diesel oil and heavy oil from waste oil, organic waste, waste plastic, biomass like marine plants, and lignocellulosic hydrocarbon, e.g., residues remained after extracting oil from stems of crops, palm trees, canola or jatropha.

Further, another object of the present invention is to a catalyst which can produce high quality of oil such as gasoline, diesel oil and heavy oil from waste oil, organic waste, waste plastic, biomass like marine plants, and lignocellulosic hydrocarbon, e.g., residues remained after extracting oil from stems of crops, palm trees, canola or jatropha.

To achieve the object of the present invention, the present invention provides a system for producing oil from waste material, including a catalytic decomposition reactor D in which a stirrer for stirring one or two or more kinds of raw materials selected from a group consisting of lingo cellulosic hydrocarbon, biomass like marine plants, waste plastic, waste, waste oil, RDF (Refuse derived fuel) and RPF (Refuse plastic fuel), and a catalyst for decomposing the selected raw materials are provided to decompose the raw materials and produce vapor and gaseous oil and sludge; a condenser F which condenses the gaseous oil generated from the catalytic decomposition reactor D; a storing container G which stores oil condensed from the condenser F; and a distillation tower H which distills the oil from the storing container G using heat of a steam boiler P and collects heavy oil, diesel oil and gasoline through a heavy oil output port I, a diesel output port J and a gasoline output port K using difference in boiling points.

Preferably, the catalytic decomposition reactor D further comprises a hydrogen diffuser X for uniformly supplying hydrogen.

Preferably, a crusher B for partially or wholly crushing the raw material and an extruder C for heating and extruding the raw material from the crusher B to the catalytic decomposition reactor D are further provided at a front side of the catalytic decomposition reactor D.

Preferably, the raw material is heated to 120˜450° C. at the extruder C. Preferably, the system further includes an oil-water separator G′ which is disposed at a lower side of the storing container G so as to separate water and oil generated from the storing container G.

Preferably, the sludge generated from the catalytic decomposition reactor D is transferred to a screw press O by an opening operation of a valve R disposed at a lower portion of the catalytic decomposition reactor D, and solid sludge is transferred to an incinerator M to be incinerated and liquid sludge is recirculated to the catalytic decomposition reactor D by a pump S, and heat generated from the incinerator M is collected by a heat exchanger Y and then converted into electric energy by an electric generator T, and gas generated from the incinerator M is transferred to a catalytic oxidation tower L through a discharge gas tube V and decomposed into water and carbon dioxide, and residual catalyst from the incinerator M is collected into a catalyst collection tank N.

Preferably, the catalytic oxidation tower L functions to decompose the vapor and discharge gas generated from the extruder, the discharge gas generated from the distillation tower H and the gas generated from the incinerator M into carbon dioxide and water, and part or whole of heat generated from the catalytic oxidation tower L is collected by a heat exchanger L′.

Preferably, a catalytic decomposition reaction in the catalytic decomposition reactor D is started at 250˜450° C. controlled by a thermal oil boiler Q, and the stirrer is driven at 60 to 10,000 RPM.

Preferably, in an initial reaction, one or a mixture of two or more kinds of catalysts selected from a liquid catalyst group consisting of thermal oil, bunker-A oil, bunker-C oil, ship fuel and kerosene is applied in a weight ratio of 20:1˜1:20 with respect to the raw material.

Preferably, the catalyst used in the catalytic decomposition reactor D is a catalyst in which a mixture of SiO₂ and zeolite having a Si/Al ratio of 1˜60 is impregnated with one or more metals selected from Sn, Zr, Mo, Ce, Cs and the period 4 elements of Sc, V, Fe, Ni, Co, Zn and Ge, or a catalyst mixture of a catalyst prepared by ion-exchanging zeolite having a Si/Al ratio of 1˜60 with the metal and a catalyst in which SiO₂ is impregnated with the metal.

Preferably, the catalyst is used in an amount of 0.01˜20 weight % with respect to the raw material.

Further, the present invention provides a catalyst for decomposing a raw material in order to produce oil, wherein the catalyst is a catalyst in which a mixture of SiO₂ and zeolite having a Si/Al ratio of 1˜60 is impregnated with one or more metals selected from Sn, Zr, Mo, Ce, Cs and the period 4 elements of Sc, V, Fe, Ni, Co, Zn and Ge, or a catalyst mixture of a catalyst prepared by ion-exchanging zeolite having a Si/Al ratio of 1˜60 with the metal and a catalyst in which SiO₂ is impregnated with the metal.

Preferably, the catalyst is manufacture as follows: SiO₂ and zeolite are mixed in a weight ratio of 100:1˜1:100, and the mixture is impregnated with one or more metals selected from Sn, Zr, Mo, Ce, Cs and the period 4 elements of Sc, V, Fe, Ni, Co, Zn and Ge in a weight ratio of 0.01˜15%, and dried for 6 hours or more at 100˜150° C., and then calcined for 2 hours at 400˜700° C., and the catalyst is used in an amount of 0.01˜20 weight % with respect to the raw material.

Preferably, the zeolite is one or more ones selected from Modernite, Offretite, Faujasite, Ferrierite, Erionite, zeolite-A, zeolite-P, or one or more ones selected from other zeolites which are dealuminated by treatment with hydrochloric acid or sulfuric acid so as to have a high Si/Al ratio of 1˜60, and the metal ion-exchanged with the zeolite is one or more ones selected from Sn, Zr, Mo, Ce, Cs and the period 4 elements of Sc, V, Fe, Ni, Co, Zn and Ge.

Preferably, the metal ion-exchanged with the zeolite is one or more ones selected from Sn, Zr, Mo, Ce, Cs and the period 4 elements of Sc, V, Fe, Ni, Co, Zn and Ge, and the metals are ion-exchanged with the zeolite in a weight ratio of 0.01˜3%.

Preferably, the catalyst mixture of the catalyst prepared by ion-exchanging the zeolite with the metal and the catalyst in which SiO₂ is impregnated with the metal is manufactured as follows: the catalyst which is ion-exchanged with the one or more metals selected from Sn, Zr, Mo, Ce, Cs and the period 4 elements of Sc, V, Fe, Ni, Co, Zn and Ge in a weight ratio of 0.01˜3% and the catalyst in which SiO₂ is impregnated with the one or more ones selected from Sn, Zr, Mo, Ce, Cs and the period 4 elements of Sc, V, Fe, Ni, Co, Zn and Ge in a weight ratio of 0.01˜15% are mixed in a weight ratio of 100:1˜1:100, and dried for 6 hours or more at 100˜150° C., and then calcined for 2 hours or more at 400˜700° C., and the manufactured catalyst is used in an amount of 0.01˜20 weight % with respect to the raw material.

According to the present invention as described above, since oil can be produced using the waste oil, organic waste, waste plastic, biomass like marine plants, and lignocellulosic hydrocarbon, e.g., residues remained after extracting oil from stems of crops, palm trees, canola or jatropha, which have been abandoned, it is possible to utilize the waste materials and to reduce greenhouse gas such as CO₂. Therefore, it is possible to efficiently use energy by using renewable energy and also to reduce carbon dioxide emissions, thereby improving atmosphere environment.

### DESCRIPTION OF DRAWINGS

The above and other objects, features and advantages of the present invention will become apparent from the following description of preferred embodiments given in conjunction with the accompanying drawings, in which:

FIG. 1 is a schematic view of a system for producing oil from biomass, waste plastic and organic waste according to an embodiment of the present invention.

### DETAILED DESCRIPTION OF THE INVENTION

Hereinafter, the embodiments of the present invention will be described in detail with reference to accompanying drawings.

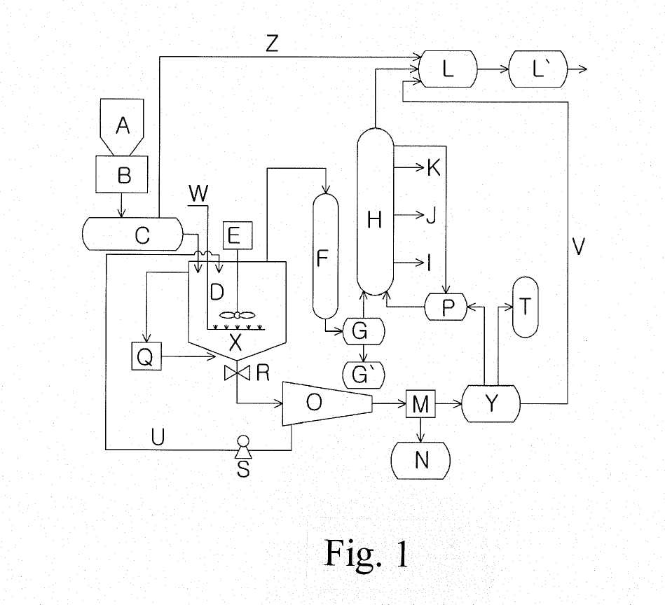

As shown in FIG. 1, the present invention provides a system which can produce good quality of oil such as gasoline, diesel oil and heavy oil using refuse plastic fuel (RPF), refuse derived fuel (RDF), waste oil, waste material, waste plastic, biomass like marine plants, and lignocellulosic hydrocarbon, e.g., residues remained after extracting oil from stems of crops, palm trees, canola or jatropha, and then produces. Further, the present invention relates to a catalyst thereof.

Referring to FIG. 1, a raw material such as the RPF, the RDF, waste oil, waste material, waste plastic, biomass like marine plants, and lignocellulosic hydrocarbon is put into a crusher B through a raw material input port A. The raw material is crushed into small pieces having a size of 3 cm or less by the crusher B, and heated to 120˜450° C. at an extruder C, and then transferred to a catalytic decomposition reactor D.

In the catalytic decomposition reactor D, a catalytic decomposition reaction is started at 250˜450° C. controlled by a thermal oil boiler Q. Herein, a stirrer E is operated at 60˜10,000 PRM so as to uniformly mix the crushed raw material. Gaseous oil generated in the catalytic decomposition reactor D is cooled through a condenser F, and stored in a storing container G, and then distilled in a distillation tower H heated by a steam boiler P. Further, as shown in FIG. 1, oil and water generated from the storing container G are separated from each other in an oil-water separator G′.

In the distillation tower H, gasoline is obtained at a boiling point of 30˜250° C. through a gasoline output port K, diesel oil is obtained at 200˜350° C. through a diesel output port J, heavy oil is obtained at 350˜450° C. through a heavy oil output port I. Gas output from the distillation tower H is decomposed into carbon dioxide and water, while being passed through a catalytic oxidation tower L, and heat generated at this time is collected through a heat exchanger L′.

The catalytic decomposition reactor D is heated by thermal oil heated in the thermal oil boiler Q. In the catalytic decomposition reactor D, if char type solid contents remained after the decomposition of the raw material such as biomass and waste plastic are increased to more than a predetermined volume, a valve R is opened, and the solid contents are transferred to a screw press O. Herein, liquid generated while the solid contents are passed through the screw press O is recirculated to the catalytic decomposition reactor D through a recirculation tube U by a pump S.

Solids discharged through the screw press O is a mixture of a catalyst and the char type solid contents. The solids are incinerated in an incinerator M, and heat of discharge gas is collected by a heat exchanger Y and then used as a heating source of the steam boiler P and an electric generator T. The discharge gas is transferred to the catalytic oxidation tower L through a discharge gas tube V and then decomposed into water and carbon dioxide. Heat generated at this time is collected by the heat exchanger L′. The catalyst remained after being incinerated in the incinerator M is collected into a catalyst collection tank N and then reused.

The vapor and discharge gas generated from the raw material by the extruder C is transferred to the catalytic oxidation tower L through a vapor and discharge gas tube Z and then decomposed into water and carbon dioxide. And Heat generated at this time is collected by the heat exchanger L′. Hydrogen may be uniformly supplied to a hydrogen diffuser X through a hydrogen supplying tube W in order to decompose the raw material such as the biomass and the waste plastic and also to increase the efficiency in oil production.

In the initial reaction, one or a mixture of two or more kinds of catalysts selected from a liquid catalyst group comprising thermal oil, bunker-A oil, bunker-C oil, ship fuel and kerosene is applied in a weight ratio of 20:1˜1:20 with respect to the raw material such as the biomass and the waste plastic. If the weight ratio is get out of the above-mentioned range, the decomposition reaction may be slowed or oil production yield may be deteriorated remarkably. The thermal oil includes various kinds of available products such as Molytherm, Thermino and Syltherm, but it is not limited to a certain product.

In order to improve the decomposition reaction of the raw material and the oil production yield, the catalyst used in the catalytic decomposition reactor D may be a catalyst in which a mixture of SiO₂ and zeolite having a Si/Al ratio of 1˜60 is impregnated with one or more metals selected from Sn, Zr, Mo, Ce, Cs and the period 4 elements of Sc, V, Fe, Ni, Co, Zn and Ge, or a catalyst mixture of a catalyst prepared by ion-exchanging zeolite having a Si/Al ratio of 1˜60 with the above-mentioned metal and a catalyst in which SiO₂ is impregnated with the above-mentioned metal.

The catalyst is manufactured as follows: SiO₂ and zeolite are mixed in a weight ratio of 100:1˜1:100, and the mixture is impregnated with one or more metals selected from Sn, Zr, Mo, Ce, Cs and the period 4 elements of Sc, V, Fe, Ni, Co, Zn and Ge in a weight ratio of 0.01˜15%, and dried for 6 hours or more at 100˜150° C., and then calcined for 2 hours at 400˜700° C. Preferably, the catalyst is used in an amount of 0.01˜20 weight % with respect to the raw material. If the amount of the catalyst is get out of the above-mentioned range, the decomposition of the raw material and the oil production yield may be deteriorated remarkably.

The zeolite may be one or more ones selected from Modemite, Offretite, Faujasite, Ferrierite, Erionite, zeolite-A, zeolite-P, or one or more ones selected from other zeolites which are dealuminated by treatment with hydrochloric acid or sulfuric acid so as to have a high Si/Al ratio of 1˜60. The metal ion-exchanged with the zeolite is one or more ones selected from Sn, Zr, Mo, Ce, Cs and the period 4 elements of Sc, V, Fe, Ni, Co, Zn and Ge.

The one or more metals are selected from Sn, Zr, Mo, Ce, Cs and the period 4 elements of Sc, V, Fe, Ni, Co, Zn and Ge, and the metals are ion-exchanged with the zeolite in a weight ratio of 0.01˜3%.

The catalyst mixture of the catalyst prepared by ion-exchanging the zeolite with the above-mentioned metal and the catalyst in which SiO₂ is impregnated with the above-mentioned metal is manufactured as follows: the catalyst which is ion-exchanged with the one or more metals selected from Sn, Zr, Mo, Ce, Cs and the period 4 elements of Sc, V, Fe, Ni, Co, Zn and Ge in a weight ratio of 0.01˜3% and the catalyst in which SiO₂ is impregnated with the one or more ones selected from Sn, Zr, Mo, Ce, Cs and the period 4 elements of Sc, V, Fe, Ni, Co, Zn and Ge in a weight ratio of 0.01˜15% are mixed in a weight ratio of 100:1˜1:100, and dried for 6 hours or more at 100˜150° C., and then calcined for 2 hours or more at 400˜700° C. Preferably, the manufactured catalyst is used in an amount of 0.01˜20 weight % with respect to the raw material. If the amount of the catalyst is get out of the above-mentioned range, the decomposition of the raw material such as the biomass, the waste plastic and the organic waste and the oil production yield may be deteriorated remarkably.

Unlike a conventional decomposition catalyst including ZSM-5 zeolite by which gas composition of less than C₄ is mainly generated due to indiscriminate cracking of a C—C or C—H bond and the rest is rest is generated in the form of tar, the catalyst used in the present invention functions to preferentially break a C—O bond of cellulose ((C₆H₁₀O₅)n), hemi cellulose ((C₆H₁₀O₅.C₅H₈O₄)n), lignin ((CH_{0.8}.0.3(H₂O))n), ligncellulose ((CH_{0.2}.0.66(H₂O))n) which are components of lignocellulosic hydrocarbon. Herein, the cellulose or hemi cellulose is firstly changed into anhydrous cellulose at a lower temperature of about 400° C. or less, and the C—O bond of the anhydrous cellulose is primarily broken by contacting with a surface of the catalyst, and then the C—C bond is broken, and thus raw material is mainly converted into a distillate fraction of C₁₁˜C₂₁ having a diesel fuel composition by properties of the catalyst, and some parts thereof are converted into a distillate fraction of C₅˜C₁₀ and some parts thereof are remained in the form of tar.

Hereinafter, the present invention will be described on the basis of embodiments and comparative examples. However, present invention is not limited to the embodiments and comparative examples.

### First embodiment

At the raw material input port A, rice straw as the biomass is crushed into small pieces having a size of 3 cm or less by the crusher B, heated to 350° C. by the extruder C, and then transferred to the catalytic decomposition reactor D, and a catalytic decomposition reaction is performed at 380° C. controlled by the thermal oil boiler Q. Herein, the stirrer E is operated at 50,000 PRM so as to continuously and uniformly mix the crushed rice straw while the catalytic decomposition reaction is performed, and gaseous oil generated in the catalytic decomposition reactor D is cooled through the condenser F, and stored in the storing container G, and then water is separated by the oil-water separator G′. And the oil from which water is separated is distilled in the distillation tower H heated by the steam boiler P, such that gasoline is obtained at a boiling point of 30˜250° C. through the gasoline output port K, diesel oil is obtained at 200˜350° C. through the diesel output port J, heavy oil is obtained at 350˜450° C. through the heavy oil output port I. Gas discharged from the distillation tower H is decomposed into carbon dioxide and water while being passed through the catalytic oxidation tower L, and then discharged to the outside, and heat generated at this time is collected through a heat exchanger L′. And vapor and discharge gas generated from the raw material by the heating of the extruder C is transferred to the catalytic oxidation tower L through the vapor and discharge gas tube Z and decomposed into water and carbon dioxide and then discharged to the outside. And Heat generated at this time is collected by the heat exchanger L′. If char type solid contents remained after the decomposition of the rice straw are increased to more than a half of a volume of the catalytic decomposition reactor D, the valve R is opened, and the solid contents are transferred to the screw press O. Liquid generated while the solid contents are passed through the screw press O is recirculated to the catalytic decomposition reactor D through the recirculation tube U by the pump S. And solids discharged through the screw press O is a mixture of the catalyst and the char type solid contents. The solids are incinerated in the incinerator M, and heat of discharge gas generated at this time is collected by the heat exchanger Y and then used as a heating source of the steam boiler P and the electric generator T. The discharge gas is transferred to the catalytic oxidation tower L through the discharge gas tube V, and decomposed into water and carbon dioxide, and then discharged to the outside. Heat generated at this time is collected by the heat exchanger L′. The catalyst remained after being incinerated in the incinerator M is collected into a catalyst collection tank N and then reused. In the initial reaction, thermal oil (Syltherm) used as a liquid catalyst is applied in a weight ratio of 15:1 with respect to the rice straw.

In order to improve the decomposition reaction of the rice straw and the oil production yield, the catalyst used in the catalytic decomposition reactor D is manufactured as follows: SiO₂ and zeolite prepared by soaking Mordenite for 1 hour in hydrochloric acid of 3N and then washing it so as to have a Si/Al ratio of 3 are mixed in a weight ratio of 1:1, and the mixture of SiO₂ and zeolite is impregnated with 13 weight % of Sc and dried for 8 hours at 150° C. and then calcined for 3 hours at 550° C. The catalyst is used in an amount of 10 weight % with respect to the raw material.

### Second Embodiment

RDF as the biomass is input through the raw material input port A heated to 150° C. by the extruder C, and then transferred to the catalytic decomposition reactor D, and a catalytic decomposition reaction is performed at 430° C. controlled by the thermal oil boiler Q. Herein, the stirrer E is operated at 90,000 PRM, and hydrogen is uniformly supplied to the hydrogen diffuser X through the hydrogen supplying tube W in order to increase the efficiency in the decomposition of RDF and the oil production. The catalyst used in the catalytic decomposition reactor D is manufactured as follows: SiO₂ and zeolite prepared by soaking Y-zeolite (Faujasite) for 3 hour in hydrochloric acid of 3N and then washing it so as to have a Si/Al ratio of 55 are mixed in a weight ratio of 1:90, and the mixture of SiO₂ and zeolite is impregnated with 0.1 weight % of Sc and dried for 12 hours at 120° C. and then calcined for 3 hours at 450° C. The catalyst is used in an amount of 0.1 weight % with respect to the raw material. The second embodiment is performed in the same manner as the first embodiment except that bunker-A used as a liquid catalyst is applied in a weight ratio of 10:1 with respect to RDF upon the initial reaction.

### Third embodiment

RPF as the waste plastic is input through the raw material input port A, heated to 250° C. by the extruder C, and then transferred to the catalytic decomposition reactor D, and a catalytic decomposition reaction is performed at 280° C. controlled by the thermal oil boiler Q. Herein, the stirrer E is operated at 100 PRM, and hydrogen is uniformly supplied to the hydrogen diffuser X through the hydrogen supplying tube W in order to increase the efficiency in the decomposition of RPF and the oil production. The catalyst used in the catalytic decomposition reactor D is manufactured as follows: SiO₂ and zeolite prepared by soaking Erionite for 6 hour in hydrochloric acid of 3N and then washing it so as to have a Si/Al ratio of 30 are mixed in a weight ratio of 90:1, and the mixture of SiO₂ and zeolite is impregnated with 7 weight % of a mixture of Zn and Sn mixed in a weight ratio of 1:1 and dried for 24 hours at 100° C. and then calcined for 3 hours at 650° C. The catalyst is used in an amount of 18 weight % with respect to the raw material. The third embodiment is performed in the same manner as the first embodiment except that kerosine used as a liquid catalyst is applied in a weight ratio of 1:15 with respect to RPF upon the initial reaction.

### Fourth Embodiment

Dried green algae and RDF as the biomass are input through the raw material input port A in a weight ratio of 1:1, heated to 300° C. by the extruder C, and then transferred to the catalytic decomposition reactor D, and a catalytic decomposition reaction is performed at 350° C. controlled by the thermal oil boiler Q. Herein, the stirrer E is operated at 1,000 PRM. The catalyst used in the catalytic decomposition reactor D is manufactured as follows: SiO₂ and zeolite prepared by soaking zeolite-P for 4 hour in sulfuric acid of 3N and then washing it so as to have a Si/Al ratio of 10 are mixed in a weight ratio of 1:10, and the mixture of SiO₂ and zeolite is impregnated with 2 weight % of a mixture of Co and Zr mixed in a weight ratio of 1:1 and dried for 6 hours at 150° C. and then calcined for 3 hours at 600° C. The catalyst is used in an amount of 6 weight % with respect to the raw material. The fourth embodiment is performed in the same manner as the first embodiment except that diesel oil used as a liquid catalyst is applied in a weight ratio of 1:1 with respect to the green algae upon the initial reaction.

### Fifth Embodiment

RPF as the waste plastic is input through the raw material input port A, heated to 250° C. by the extruder C, and then transferred to the catalytic decomposition reactor D, and a catalytic decomposition reaction is performed at 280° C. controlled by the thermal oil boiler Q. Herein, the stirrer E is operated at 100 PRM, and hydrogen is uniformly supplied to the hydrogen diffuser X through the hydrogen supplying tube W in order to increase the efficiency in the decomposition of RPF and the oil production. The catalyst used in the catalytic decomposition reactor D is manufactured as follows: Ferrierite and SiO₂ are mixed in a weight ratio of 5:1, and the mixture of SiO₂ and Ferrierite is impregnated with 1 weight % of a mixture of Ni and Ge mixed in a weight ratio of 1:1 and dried for 7 hours at 130° C. and then calcined for 3 hours at 500° C. The catalyst is used in an amount of 18 weight % with respect to the raw material. The fifth embodiment is performed in the same manner as the first embodiment except that kerosine used as a liquid catalyst is applied in a weight ratio of 1:15 with respect to RPF upon the initial reaction.

### Sixth Embodiment

Residues remained after squeezing palm oil as the biomass are input through the raw material input port A, heated to 450° C. by the extruder C, and then transferred to the catalytic decomposition reactor D, and a catalytic decomposition reaction is performed at 440° C. controlled by the thermal oil boiler Q. Herein, the stirrer E is operated at 3,000 PRM, and hydrogen is uniformly supplied to the hydrogen diffuser X through the hydrogen supplying tube W The catalyst used in the catalytic decomposition reactor D is manufactured as follows: SiO₂ which is impregnated with 5 weight % of Ge and Ce mixed in a weight ratio of 1:1 and zeolite-A which is soaked for 6 hour in sulfuric acid of 3N, washed to have a Si/Al ratio of 5 and then ion-exchanged with 2 weight % of V are mixed in a weight ratio of 1:60, and the mixture of SiO₂ and zeolite-A is dried for 6 hours at 150° C. and then calcined for 3 hours at 700° C. The catalyst is used in an amount of 10 weight % with respect to the raw material. The sixth embodiment is performed in the same manner as the first embodiment except that thermal oil (Therminol) used as a liquid catalyst is applied in a weight ratio of 1:3 with respect to the raw material upon the initial reaction.

### Seventh Embodiment

Corn stems as the biomass and ROF as the waste plastic are input through the raw material input port A in a weight ratio of 1:1, heated to 360° C. by the extruder C, and then transferred to the catalytic decomposition reactor D, and a catalytic decomposition reaction is performed at 360° C. controlled by the thermal oil boiler Q. The catalyst used in the catalytic decomposition reactor D is manufactured as follows: SiO₂ which is impregnated with 0.5 weight % of Sc and Cs mixed in a weight ratio of 1:1 and Offretite which is soaked for 6 hour in sulfuric acid of 3N, washed to have a Si/Al ratio of 20 and then ion-exchanged with 0.1 weight % of Fe are mixed in a weight ratio of 20:1, and the mixture of SiO₂ and Offretite is dried for 6 hours at 150° C. and then calcined for 3 hours at 600° C. The catalyst is used in an amount of 5 weight % with respect to the raw material. The seventh embodiment is performed in the same manner as the first embodiment except that a mixture of thermal oil (Molytherm) and diesel oil which are mixed in a weight ratio of 1:1 so as to be used as a liquid catalyst, is applied in a weight ratio of 3:1 with respect to the raw material upon the initial reaction.

### Eighth Embodiment

Corn stems and sugar cane stems as the biomass are input through the raw material input port A in a weight ratio of 1:1, heated to 360° C. by the extruder C, and then transferred to the catalytic decomposition reactor D, and a catalytic decomposition reaction is performed at 360° C. controlled by the thermal oil boiler Q The catalyst used in the catalytic decomposition reactor D is manufactured as follows: SiO₂ which is impregnated with 5 weight % of V and Cs mixed in a weight ratio of 1:1 and a mixture of Modernite and Zeolite-X (Faujasite) soaked for 8 hour in sulfuric acid of 3N and washed to have a Si/Al ratio of 40, which are respectively ion-exchanged with 1 weight % of Mo and then mixed in a weight ratio of 1:1, are mixed in a weight ratio of 2:1, and the mixture of SiO₂ and the mixture of Modernite and Zeolite-X is dried for 6 hours at 150° C. and then calcined for 3 hours at 400° C.

The catalyst is used in an amount of 10 weight % with respect to the raw material. The eighth embodiment is performed in the same manner as the first embodiment except that ship fuel used as a liquid catalyst is applied in a weight ratio of 1:3 with respect to the raw material upon the initial reaction.

### FIRST COMPARATIVE EXAMPLE

A first comparative example is carried out in the same manner as the first embodiment except that the catalyst is not applied in the catalytic decomposition reactor D.

### SECOND COMPARATIVE EXAMPLE

A second comparative example is carried out in the same manner as the first embodiment except that a ZSM-5 catalyst which is impregnated with 1 weight % of Pt is applied in the catalytic decomposition reactor D.

### THIRD COMPARATIVE EXAMPLE

A third comparative example is carried out in the same manner as the first embodiment except that a catalyst in which H-X zeolite which is ion-exchanged with hydrogen and USY (Ultra Stable Y-zeolite) as FCC(Fluid Catalytic Cracking) catalyst are mixed in a weight ratio 1:1 is applied in the catalytic decomposition reactor D. The properties and compositions of oil obtained by using the catalysts prepared in the embodiments and the comparative examples in the catalytic decomposition reactor D are analyzed and indicated in table 1.

TABLE 1

| | Gas | Gasoline | Diesel | Heavy | Total |
|---|---|---|---|---|---|
| | yield | yield | yield | yield | yield |
| | (C₁ to C₄) | (C₅ to C₁₂) | (C₁₃ to C₂₂) | (C₂₃ to C₃₀) | (C₅ to C₃₀) |
| Embodiments | (%) | (%) | (%) | (%) | (%) |
| First | 1 | 12 | 43 | 3 | 58 |
| embodiment | | | | | |
| Second | 2 | 17 | 45 | 2 | 64 |
| embodiment | | | | | |
| Third | 2 | 20 | 48 | 2 | 78 |
| embodiment | | | | | |
| Fourth | 1 | 11 | 43 | 3 | 57 |
| embodiment | | | | | |
| Fifth | 1 | 16 | 46 | 4 | 66 |
| embodiment | | | | | |
| Sixth | 1 | 15 | 46 | 3 | 64 |
| embodiment | | | | | |
| Seventh | 1 | 13 | 43 | 3 | 59 |
| embodiment | | | | | |
| Eighth | 1 | 13 | 42 | 3 | 58 |
| embodiment | | | | | |
| First | 0 | 0 | 0 | 1 | 1 |
| comparative | | | | | |
| example | | | | | |
| Second | 34 | 3 | 0 | 0 | 3 |
| comparative | | | | | |
| example | | | | | |
| Third | 31 | 2 | 0 | 0 | 2 |
| comparative | | | | | |
| example | | | | | |

### INDUSTRIAL APPLICABILITY

As shown in table 1, since the biomass, the waste plastic, RDF, RPF and the like can be converted into the good quality of gasoline, diesel and heavy oil using the catalytic decomposition reaction described in the embodiments, it is possible to utilize the waste materials and to reduce greenhouse gas such as CO₂. Therefore, it is possible to efficiently use energy by using renewable energy and also to reduce carbon dioxide emissions, thereby improving atmosphere environment.

While the present invention has been described with respect to the specific embodiments, it will be apparent to those skilled in the art that various changes and modifications may be made without departing from the spirit and scope of the invention as defined in the following claims.

What is claimed is:

1. A system for producing oil from waste material, comprising:
a catalytic decomposition reactor (D) providing a stirrer for stirring at least one kind of raw material; the raw material being selected from a group consisting of lingo cellulosic hydrocarbon, biomass like marine plants, waste plastic, waste, waste oil, RDF (Refuse derived fuel) and RPF (Refuse plastic fuel), and a catalyst for decomposing the selected raw materials; the catalytic decomposition reactor serving for decomposing the raw materials and producing vapor and gaseous oil and sludge; and
a condenser (F) for condensing the gaseous oil generated from the catalytic decomposition reactor (D); a storing container (G) for storing oil condensed from the condenser (F); and a distillation tower (H) for distilling the oil from the storing container (G) by heat from a steam boiler (P) and collecting heavy oil, diesel oil and gasoline through a heavy oil output port (I), a diesel output port (J) and a gasoline output port (K) at difference boiling points.

2. The system according to claim 1, wherein the catalytic decomposition reactor (D) further comprises a hydrogen diffuser (X) for uniformly supplying hydrogen.

3. The system according to claim 1, wherein a crusher (B) for partially or wholly crushing the raw material and an extruder C for heating and extruding the raw material from the crusher (B) to the catalytic decomposition reactor (D) are further provided at a front side of the catalytic decomposition reactor (D).

4. The system according to claim 3, wherein the raw material is heated to 120˜450° C. at the extruder (C).

5. The system according to claim 1, further comprising an oil-water separator (G′) which is disposed at a lower side of the storing container G so as to separate water and oil generated from the storing container G

6. The system according to claim 1, wherein the sludge generated from the catalytic decomposition reactor (D) is transferred to a screw press (O) by an opening operation of a valve \hat{R} disposed at a lower portion of the catalytic decomposition reactor (D), and solid sludge is transferred to an incinerator (M) to be incinerated and liquid sludge is recirculated to the catalytic decomposition reactor (D) by a pump (S), and
wherein heat generated from the incinerator (M) is collected by a heat exchanger (Y) and then converted into electric energy by an electric generator (T), and gas generated from the incinerator (M) is transferred to a catalytic oxidation tower (L) through a discharge gas tube (V) and decomposed into water and carbon dioxide, and residual catalyst from the incinerator (M) is collected into a catalyst collection tank (N).

7. The system according to claim 6, wherein the catalytic oxidation tower (L) functions to decompose the vapor and discharge gas generated from the extruder, the discharge gas generated from the distillation tower (H) and the gas generated from the incinerator M into carbon dioxide and water, and part or whole of heat generated from the catalytic oxidation tower (L) is collected by a heat exchanger (L′).

8. The system according to claim 1, wherein a catalytic decomposition reaction in the catalytic decomposition reactor (D) is started at 250˜450° C. controlled by a thermal oil boiler (Q), and the stirrer is driven to rotate at 60 to 10,000 RPM.

9. The system according to claim 1, wherein, in an initial reaction, one or a mixture of two or more kinds of catalysts selected from a liquid catalyst group consisting of thermal oil, bunker-A oil, bunker-C oil, ship fuel and kerosene is applied in a weight ratio of 20:1˜1:20 with respect to the raw material.

10. The system according claim 1, wherein the catalyst used in the catalytic decomposition reactor (D) is a catalyst in which a mixture of SiO₂ and zeolite having a Si/Al ratio of 1˜60 is impregnated with one or more metals selected from Sn, Zr, Mo, Ce, Cs and the period 4 elements of Sc, V, Fe, Ni, Co, Zn and Ge, or is a catalyst mixture of a catalyst prepared by ion-exchanging zeolite having a Si/Al ratio of 1˜60 with the metal and a catalyst in which SiO₂ is impregnated with the metal.

11. The system according to claim 10, wherein the catalyst is used in an amount of 0.01˜20 weight % with respect to the raw material.

12. A catalyst for decomposing a raw material in order to produce oil, wherein the catalyst is a catalyst in which a mixture of SiO₂ and zeolite having a Si/Al ratio of 1˜60 is impregnated with one or more metals selected from Sn, Zr, Mo, Ce, Cs and the period 4 elements of Sc, V, Fe, Ni, Co, Zn and Ge, or is a catalyst mixture of a catalyst prepared by ion-exchanging zeolite having a Si/Al ratio of 1˜60 with the metal and a catalyst in which SiO₂ is impregnated with the metal.

13. The catalyst according to claim 12, wherein the catalyst is manufactured as follows:
SiO₂ and zeolite are mixed in a weight ratio of 100:1˜1:100, and the mixture is impregnated with one or more metals selected from Sn, Zr, Mo, Ce, Cs and the period 4 elements of Sc, V, Fe, Ni, Co, Zn and Ge in a weight ratio of 0.01˜15%, and being dried for 6 hours or more at 100˜150° C., and then being calcined for 2 hours at 400˜700° C., and the catalyst is used in an amount of 0.01˜20 weight % with respect to the raw material.

14. The catalyst according to claim 12, wherein the zeolite is one or more ones selected from Modernite, Offretite, Faujasite, Ferrierite, Erionite, zeolite-A, zeolite-P, or one or more ones selected from other zeolites which are dealuminated by treatment with hydrochloric acid or sulfuric acid so as to have a high Si/Al ratio of 1˜60, and the metal ion-exchanged with the zeolite is one or more ones selected from Sn, Zr, Mo, Ce, Cs and the period 4 elements of Sc, V, Fe, Ni, Co, Zn and Ge.

15. The catalyst according to claim 12, wherein the metal ion-exchanged with the zeolite is selected from Sn, Zr, Mo, Ce, Cs and the period 4 elements of Sc, V, Fe, Ni, Co, Zn and Ge, or the combination of these elements; and the metals are ion-exchanged with the zeolite in a weight ratio of 0.01˜3%.

16. The catalyst according to claim 12, wherein the catalyst mixture of the catalyst prepared by ion-exchanging the zeolite with the metal;
the catalyst in which SiO₂ is impregnated with the metal is manufactured as follows:
the catalyst which is ion-exchanged with the one or more metals selected from Sn, Zr, Mo, Ce, Cs and the period 4 elements of Sc, V, Fe, Ni, Co, Zn and Ge in a weight ratio of 0.01˜3%; and
the catalyst in which SiO₂ is impregnated with the one or more ones selected from Sri, Zr, Mo, Ce, Cs and the period 4 elements of Sc, V, Fe, Ni, Co, Zn and Ge in a weight ratio of 0.01˜15% are mixed in a weight ratio of 100:1˜1:100, and dried for 6 hours or more at 100˜150° C., and then calcined for 2 hours or more at 400˜700° C., and the manufactured catalyst is used in an amount of 0.01˜20 weight % with respect to the raw material.
